(19) United States
(12) Patent Application Publication
(10) Pub. No.: US 2009/0177537 A1
(43) Pub. Date: Jul. 9, 2009

(54) VIDEO ADVERTISEMENT PRICING

(75) Inventors: Karen Padham Taylor, Los Gatos, CA (US); Manish Gupta, Santa Clara, CA (US); Daniel Dulitz, Mountain View, CA (US)

Correspondence Address: FISH & RICHARDSON P.C., PO BOX 1022, MINNEAPOLIS, MN, 55440-1022, US

(73) Assignee: GOOGLE INC., Mountain View, CA (US)

(21) Appl. No.: 11/970,170

(22) Filed: Jan. 7, 2008

(51) Int. Cl. G06Q 30/00; G06Q 10/00

(52) U.S. Cl. 705/14; 705/30; 705/400

(57) ABSTRACT

A query including one or more keywords is received from a client device, and an advertisement relevant to the one or more keywords is identified, wherein the advertisement is associated with a video. Display data for displaying the advertisement at the client device is generated. Video selection data for displaying a video element proximate to the advertisement at the client device is also generated. The display data and the video selection data are provided to the client device, and an account of an advertiser associated with the advertisement is updated an amount in response to receiving data indicating a selection of the advertisement or the video element.

### BACKGROUND

This disclosure relates to information retrieval.

Content items, e.g., advertisements, can be identified by a search engine in response to a query by a user. The query can include one or more search terms, and the search engine can identify and rank the content items based on the search terms, e.g., keywords, in the query and on one or more parameters associated with the content item. The advertisements can also be associated with videos that are displayed along with the advertisements.

In some online advertising systems, advertisers pay for their advertisements on a cost-per-click (CPC) basis. Each time the video associated with the advertisement is viewed, the advertiser may not be charged any additional amount than the cost-per-click. Other pricing models, however, can also be used.

### SUMMARY

Disclosed herein are systems, apparatus, computer program products and methods for identifying videos associated with advertisements. In an implementation, a query is received including one or more keywords. A content item relevant to the one or more keywords is identified, wherein the content item is associated with a video. Display data for displaying the content item is generated, and video selection data for displaying a video element proximate to the content item is generated. The display data and the video selection data are provided to a device, and an account of a sponsor associated with the content item is updated an amount in response to receiving data indicating an interaction with the content item or the video element.

In another implementation, an advertisement is received from an advertiser, wherein the advertisement is associated with a video and a landing page. A cost-per-click is associated with the landing page and a cost-per-view is associated with the video. The advertisement, a link to the landing page, and a video element related to the video is provided to the client device. An indication of a selection of the video or the link is received, and an account of an advertiser associated with the advertisement is updated at least one of the cost-per-click or the cost-per-view based on the indication received.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example online content delivery system.

FIG. 2 is a block diagram of an example system that selects videos using relevancy measures and quality scores.

FIG. 3 is a flow diagram of an example process for charging an advertiser associated with a video.

FIG. 4 is a flow diagram of an example process for updating an account of an advertiser associated with the advertisement an amount in response to receiving data indicating a selection of the video element.

FIG. 5 is a flow diagram of an example process for charging an advertiser associated with the advertisement an amount in response to receiving data indicating a selection of the video element.

FIG. 6 is a flow diagram of another example process for charging an advertiser associated with a video.

FIG. 7 is another flow diagram of another example process for receiving an indication of a selection of the video or a link.

FIG. 8 is another flow diagram of an example process for updating an account of the advertiser associated with the advertisement at least one of the cost-per-click or the cost-per-view based on the indication received.

FIG. 9 is a schematic diagram of an example computer system that can be utilized to implement the systems and methods described herein.

### DETAILED DESCRIPTION

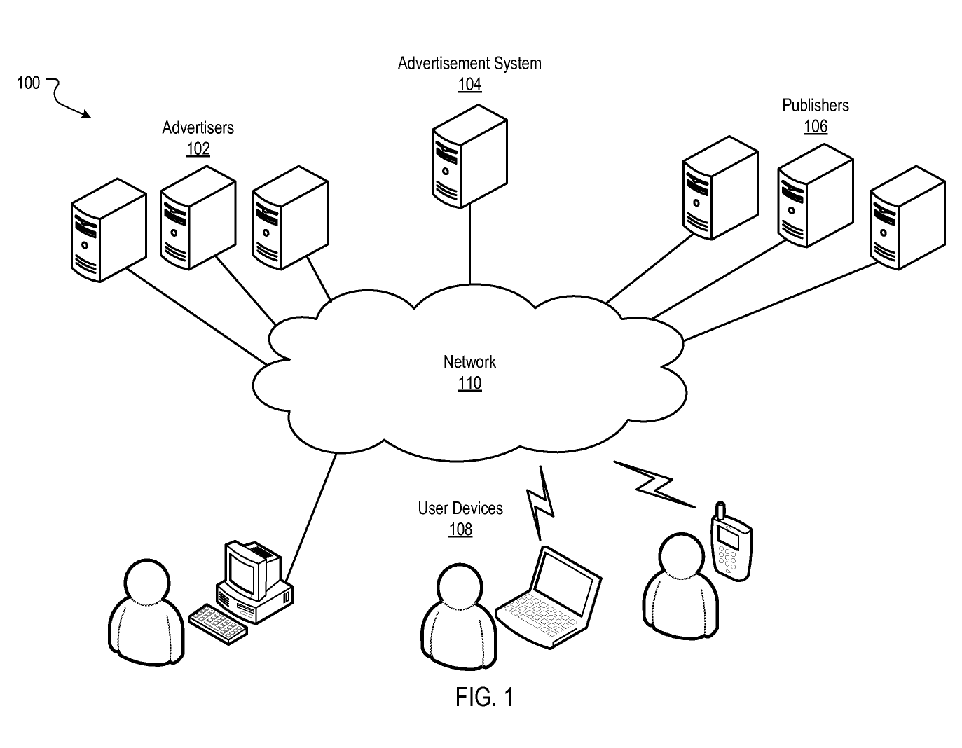

FIG. 1 is a block diagram of an example online content delivery (e.g., advertising) system 100. The system 100 provides sponsored content in response to, for example, a query. By way of example, the sponsored content can be in the form of advertising or advertisements (“ads”). Though the system is described with reference to providing advertisements, the system 100 can provide other forms of content, including other forms of sponsored content.

A computer network 110, such as a local area network (LAN), wide area network (WAN), the Internet, or a combination thereof, connects the advertisers 102 (sponsors), an advertisement system 104, publishers 106, and users devices 108. In some implementations, the one or more advertisers 102 can directly, or indirectly, enter, maintain, and track advertisement (“ad”) information in the advertisement system 104. The advertisements may be in the form of graphical advertisements, such as banner advertisements, text only advertisements, image advertisements, audio advertisements, video advertisements, advertisements combining one of more of any of such components, etc. The advertisements may also include embedded information, such as links, meta-information, and/or machine executable instructions. One or more publishers 106 may submit requests for advertisements to the system 104. The system 104 responds by sending advertisements (e.g., when an associated publication is rendered) to the requesting publisher 106 for placement on one or more of the publisher's web properties (e.g., websites and other network-distributed content). As discussed above, while reference is made to advertisements, other content items can be provided by the system 104.

Other entities, such as user devices 108 and the advertisers 102, can provide usage information to the system 104, such as, for example, whether a click-through related to an advertisement has occurred, whether a conversion has occurred, or whether some other defined event has occurred. Such usage information can be processed to measure performance metrics, such as click-through rates, conversion rates, etc.

A click-through can occur, for example, when a user of a user device 108 selects or “clicks” on an advertisement. The click-through rate can be a performance metric that is obtained by dividing the number of users that clicked on the advertisement or a link associated with the advertisement by the number of times the advertisement was delivered. For example, if an advertisement is delivered 100 times, and three persons clicked on the advertisement, then the click-through rate for that advertisement is 3%. A click-through rate can also be associated with a video advertisement.

A “conversion” occurs when a user, for example, consummates a transaction related to a previously served advertisement. What constitutes a conversion may vary from case to case and can be determined in a variety of ways. For example, a conversion may occur when a user clicks on an advertisement, is referred to the advertiser's Web page and consummates a purchase there before leaving that Web page. Alternatively, a conversion may be defined as a user being shown an advertisement, and making a purchase on the advertiser's Web page within a predetermined time (e.g., seven days). In yet another alternative, a conversion may be defined by an advertiser to be any measurable/observable user action such as, for example, downloading a white paper, navigating to at least a given depth of a Website, viewing at least a certain number of Web pages, spending at least a predetermined amount of time on a Website or Web page, registering on a Website, dialing a telephone number, sending a product inquiry, etc. Other definitions of what constitutes a conversion are possible.

A conversion rate can be defined as the ratio of the number of conversions to the number of impressions of the advertisement (i.e., the number of times an advertisement is rendered) or the ratio of the number of conversions to the number of selections (or the number of some other earlier event).

Other usage information and/or performance metrics can also be used. The usage information and/or performance metrics can, for example, be revenue related or non-revenue related. In some implementations, the performance metrics can be parsed according to time, e.g., the performance of a particular content item may be determined to be very high on weekends, moderate on weekday evenings, but very low on weekday mornings and afternoons.

This usage information can include measured or observed user behavior related to advertisements that have been served. The system 104 performs financial transactions, such as crediting the publishers 106 and charging the advertisers 102 based on the usage information.

One example of a publisher 106 is a general content server that receives requests for content (e.g., articles, discussion threads, music, video, graphics, search results, web page listings, information feeds, etc.), and retrieves the requested content in response to the request. The content server may submit a request for advertisements to an advertisement server in the system 104, or embed code in the rendered page for the user device 108 to execute and retrieve the ads. The advertisement request may include a number of advertisements desired. The advertisement request may also include content request information. This information can include the content itself (e.g., page or other content document), a pointer to the content by way of a uniform resource locator (“URL”), a category corresponding to the content or the content request (e.g., arts, business, computers, arts-movies, arts-music, etc.), part or all of the content request, content age, content type (e.g., text, graphics, video, audio, mixed media, etc.), geo-location information, etc.

In some implementations, the content server can combine the requested content with one or more of the advertisements provided by the system 104. In other implementations, a user device 108 executing a browser can combine the requested content with the advertisement. This combined content and advertisements can be sent/presented to the user that requested the content. The content server can transmit information about the advertisements back to the advertisement server, including information describing how, when, and/or where the advertisements are to be rendered (e.g., in HTML or JavaScript™).

Another example publisher 106 is a search service. A search service can receive queries for search results. In response, the search service can retrieve relevant search results from an index of documents (e.g., from an index of web pages). An exemplary search service is described in the article S. Brin and L. Page, “The Anatomy of a Large-Scale Hypertextual Search Engine,” Seventh International World Wide Web Conference, Brisbane, Australia and in U.S. Pat. No. 6,285,999. Search results can include, for example, lists of web page titles, snippets of text extracted from those web pages, and hypertext links to those web pages, and may be grouped into a predetermined number of (e.g., ten) search results.

The search service can submit a request for advertisements to the system 104. The request may include a number of advertisements desired. This number may depend on the search results, the amount of screen or page space occupied by the search results, the size and shape of the advertisements, etc. In some implementations, the number of desired advertisements will be from one to ten, or from three to five. The request for advertisements may also include the query (as entered or parsed), information based on the query (such as geo-location information, whether the query came from an affiliate and an identifier of such an affiliate), and/or information associated with, or based on, the search results. Such information may include, for example, identifiers related to the search results (e.g., document identifiers or “docIDs”), scores related to the search results (e.g., information retrieval (“IR”) scores), snippets of text extracted from identified documents (e.g., web pages), full text of identified documents, feature vectors of identified documents, etc. In some implementations, IR scores can be computed from, for example, dot products of feature vectors corresponding to a query and a document, page rank scores, and/or combinations of IR scores and page rank scores, etc.

The search service can combine the search results with one or more of the advertisements provided by the system 104. This combined information can then be forwarded to the user devices 108 that requested the content. The search results can be maintained as distinct from the advertisements, so as not to confuse the user between paid advertisements and neutral search results.

Finally, the search service can transmit information about the advertisement and when, where, and/or how the advertisement was to be rendered back to the system 104.

As can be appreciated from the foregoing, the advertising system 104 can serve publishers 106 such as content servers and search services. The system 104 permits serving of advertisements targeted to content (e.g., documents) served by content servers or in response to search queries provided by users. For example, a network may include an advertisement server serving targeted advertisements in response to requests from a search service with advertisement spots for sale.

In some implementations, the advertisement system 104 may serve advertisements that include a video associated with the advertisements. The video associated with an advertisement may be displayed on the user device 108 when the associated advertisement is displayed. In some implementations, the advertiser can be charged for each click or view on the video if the video is presented along with the advertisement.

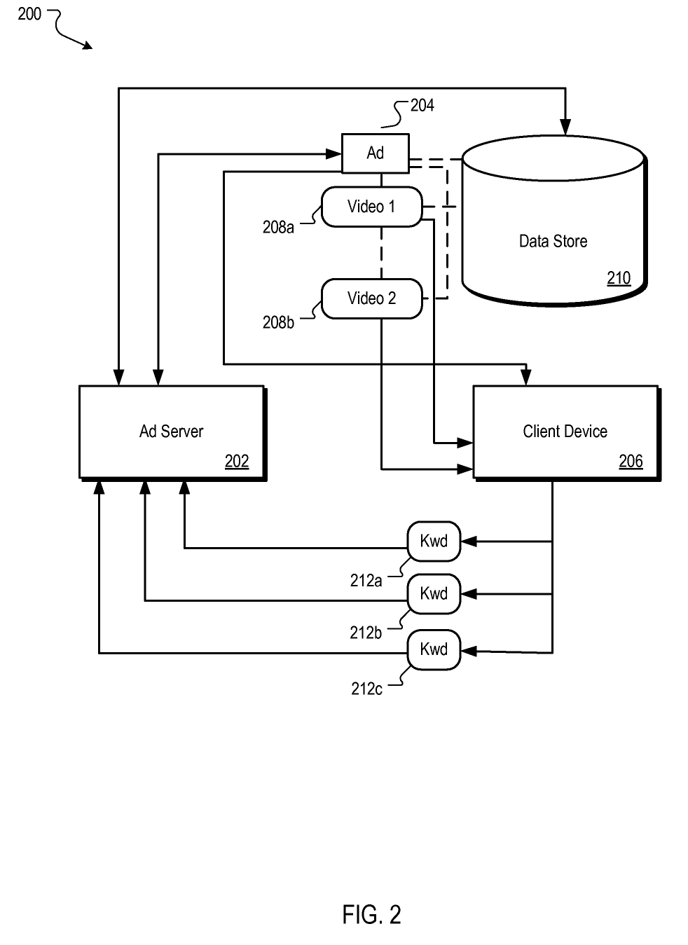

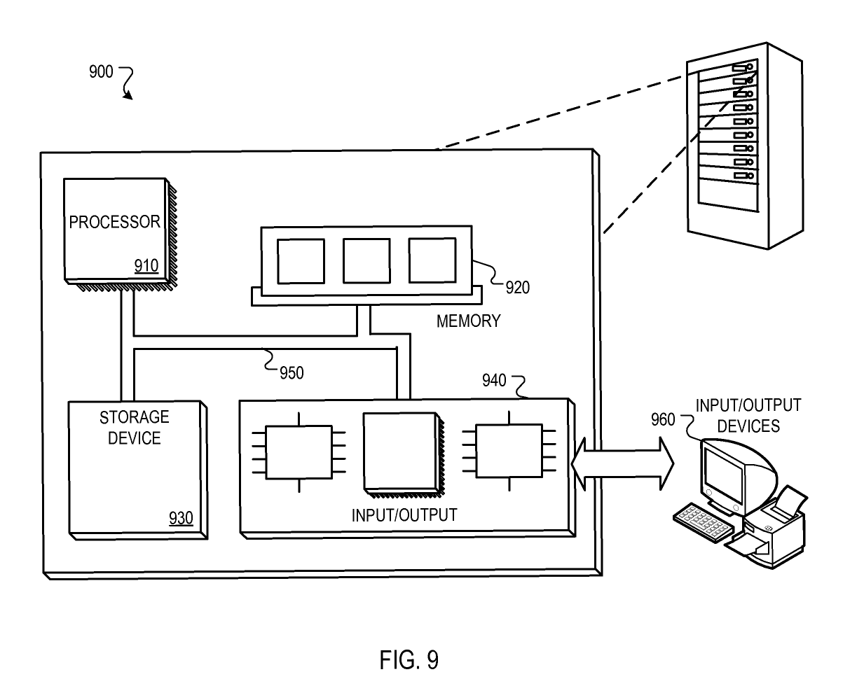

FIG. 2 is a block diagram of an example system 200 that determines how the amount an advertiser can be charged each time a video associated with the advertiser is viewed. The system 200 can, for example, be implemented in the advertisement system 104 utilizing one or more computing devices that include memory devices storing processing instructions and processing devices for executing the processing instructions. An example computing system is shown and described with reference to FIG. 9. Other implementations, however, can also be used.

In some implementations, the system 200 can include an ad server 202 that serves advertisements 204 to a client device 206. The ad server 202 can serve advertisements provided by the advertisers 102 as part of, or in coordination with, the advertisement system 104. The advertisements may be served over the network 110 and displayed on a client device 206. Example client devices 206, e.g., user device 108, can include a laptop, home computer, PDA, cell phone, set top box, game console, portable electronic device, etc.

In some implementations, the ad server 202 can serve videos 208, e.g., 208a or 208b, to the client device 206. The videos 208 may correspond to the advertisements 204 that are identified by the ad server 202 in response to a query. For example, while the advertisements 204 may be advertisements for potato peelers offered by one or more online merchants that sell potato peelers, the videos 208 associated with the advertisements 204 may be videos on how to use the potato peelers to peel potatoes as well as videos related to using the potato peelers to peel apples.

The advertisements 204 and the videos 208 may be stored in a data store 210 that stores information for advertisements that the ad server 202 can serve. When the client device 206 requests advertisements or issues a search query that results in the identification of advertisements, the ad server 202 can provide the advertisement 204. For example, the advertisement 204 may be an advertisement for a local home goods store. The advertisement 204 can be displayed on the client device 206 as the result of a search for potato peelers (e.g., using a search query “potato peeler”) entered in the user's browser.

In some implementations, the system 200 can allow an advertiser to specify videos 208 related to the advertisement 204 of the advertiser that may be displayed with that advertiser's advertisements. For example, the advertiser 102 can provide videos 208 to the system 200 to display with the advertisements 204. The videos 208 can, for example, be stored in a data store 210. When the advertisements 204 are displayed, a video still of one of the videos 208 associated with the advertisements 204 as specified by the advertiser 102 and/or a video element such as a plusbox, can be displayed. The video is not displayed initially. The plusbox indicates a video is available. When the user clicks on the video element, e.g., the plusbox, the system 200 can return the selected video 208 associated with the advertisement 204. The display can show the video still of the video 208 associated with the advertisement 204. In some implementations, the video element can include a video still image of the video 208 or a thumbnail image of the video.

In one implementation, the advertisement management system 104 includes an auction process. Advertisers 102 may be permitted to select, or bid, an amount the advertisers are willing to pay for each click of an advertisement, e.g., a cost-per-click amount an advertiser pays when, for example, a user clicks on an advertisement, for example on a link that directs the user to a landing page associated with the advertisement, as well as each click or view of a video associated with the advertisement, e.g., a cost-per-view amount. The cost-per-click and cost-per-view can include a maximum cost-per-click and a maximum cost-per-view, e.g., the maximum amount the advertiser is willing to pay for each click of advertisement based on a keyword, as well as the maximum amount the advertiser is willing to pay for each view of the video. For example, advertisers A, B, and C all select, or bid, a maximum cost-per-click of $0.50, $0.75, and $1.00, respectively. The maximum amount advertiser A will pay for a click is $0.50, the maximum amount advertiser B will pay is $1.00, and the maximum amount advertiser C will pay is $0.75. Advertisers A, B, and C can all select or bid a maximum cost-per-view of $1.00, $1.50, and $2.00, respectively. The maximum amount advertiser A will pay for a video view is $1.00, the maximum amount advertiser B will pay is $1.50, and the maximum amount advertiser C will pay is $2.00.

In some implementations, the cost-per-click and cost-per-view can also include a minimum cost-per-click and minimum cost-per-view. Each advertiser can be charged a predetermined minimum cost-per-click and cost-per-view amount. The minimum cost-per-click and minimum cost-per-view is the minimum amount the advertiser must pay for each click or view of the advertisement and video, respectively.

In some implementations, when a video element is displayed for a user, the user can decide to click on the video element to view and play the video 208. Each time the user clicks on the video element, the advertiser associated with the video 208 can be charged the cost-per-view amount. In some implementations, the user can play the video 208 by either clicking on a video element associated with the video 208 or selecting a play button associated with the video 208.

In some implementations, the cost-per-view can be based on a user only clicking on a video element to start playing the video regardless of how long the video is played. For example, the user can click on a plusbox, or a video still associated with the video 208. For example, if a user clicks on a video element and the video 208 start to play and the user then stops the video, the advertiser is still charged the cost-per-view amount.

In some implementations, the advertiser can be charged based on the amount of the video 208 that is played. The amount charged can be proportional to the length of the video 208 that is played. For example, the amount charged can be based on the minimum cost-per-click associated with the video 208. For example, suppose a user clicks on a video element and a video 208 starts to play, and the user stops the video 208 halfway through. If the advertiser associated with the video was going to pay $1.00 as a cost-per-view, the advertiser would be charged only half of the cost-per-view amount because only half of the video 208 was played by the user.

In some implementations, if a user clicks on the video element and watches any of the video 208 and then clicks on the advertisement to be directed to the landing page, then the advertiser can be charged an amount less than the minimum cost-per-click added to the minimum cost-per-view because the user clicked on both the advertisement and the video element. For example, suppose an advertiser will be charged a minimum cost-per-click amount of $0.50 for a click on an advertisement and $0.75 for a cost-per-view. If a user clicked on both the advertisement and the video element, then instead of charging the advertiser $0.50+$0.75, the advertiser can be given a discount of a predetermined amount. For example, the advertiser can be charged $1.00 instead of the regular $1.25.

In some implementations, an account associated with the advertiser is updated each time the advertiser is charged a cost-per-click or cost-per-view amount.

In summary, the system 200 of FIG. 2 can facilitate the provisioning of advertisements and related videos 208 in a variety of ways. For example, a client device 206 can send a query including one or more keywords to ad server 202. The ad server 202 can use the keywords to find an advertisement from a data store 210. The ad server 202 can determine whether videos 208 are associated with the advertisement. The ad server 202 can provide the advertisement and the video 208 to the client device 206. If a user clicks on a video element associated with the video 208, the advertiser is charged a predetermined amount for each click on the video element or on the video 208. The advertiser can be charged an amount proportional to the length of the video played or the advertiser can be charged the same amount regardless of how long the video is played by a user.

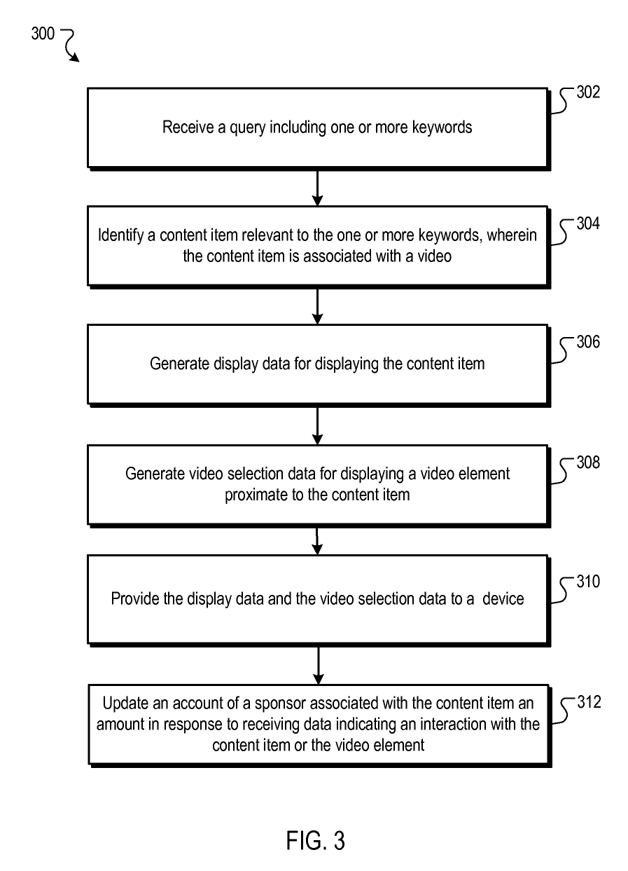

FIG. 3 is a flow diagram of an example process 300 for charging an advertiser associated with a video. The process 300 can, for example, be implemented in a system such as the system 200 of FIG. 2.

Stage 302 receives a query including one or more keywords. For example, the ad server 202 can receive a query including one or more keywords.

Stage 304 identifies a content item relevant to the one or more keywords, wherein the content item is associated with a video. For example, the ad server 202 can identify a content item relevant to the one or more keywords, wherein the content item is associated with a video

Stage 306 generates display data for displaying the content item. For example, the ad server 202 can generate display data for displaying the content item.

Stage 308 generates video selection data for displaying a video element proximate to the content item. For example, the ad server 202 can generate video selection data for displaying a video element proximate to the content item.

Stage 310 provides the display data and the video selection data to a device. For example, the ad server 202 can provide the display data and the video selection data to a device.

Stage 312 update an account of a sponsor associated with the content item an amount in response to receiving data indicating an interaction with the content item or the video element. For example, the ad server 202 can update an account of a sponsor associated with the content item an amount in response to receiving data indicating an interaction with the content item or the video element.

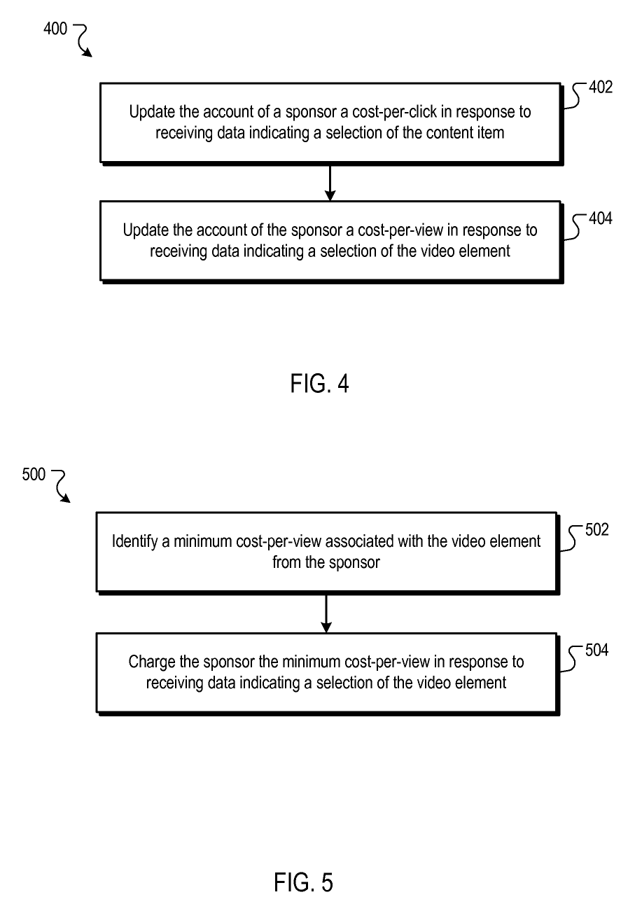

FIG. 4 is a flow diagram of an example process 400 for updating an account of a sponsor associated with the content item an amount in response to receiving data indicating a selection of the video element. The process 400 can, for example, be implemented in a system such as the system 200 of FIG. 2.

Stage 402 updates an account of a sponsor a cost-per-click in response to receiving data indicating a selection of the content item. For example, the ad server 202 can update the account of a sponsor a cost-per-click in response to receiving data indicating a selection of the content item.

Stage 404 updates the account of the sponsor a cost-per-view in response to receiving data indicating a selection of the video element. For example, the ad server 202 can update the account of the sponsor a cost-per-view in response to receiving data indicating a selection of the video element.

FIG. 5 is a flow diagram of an example process 500 for charging an advertiser associated with the advertisement an amount in response to receiving data indicating a selection of the video element. The process 500 can, for example, be implemented in a system such as the system 200 of FIG. 2.

Stage 502 identifies a minimum cost-per-view associated with the video from the sponsor. For example, the ad server 202 can identify a minimum cost-per-view associated with the video from the sponsor.

Stage 504 charges the sponsor the minimum cost-per-view in response to receiving data indicating a selection of the video element. For example, the ad server 202 can charge the sponsor the minimum cost-per-view in response to receiving data indicating a selection of the video element

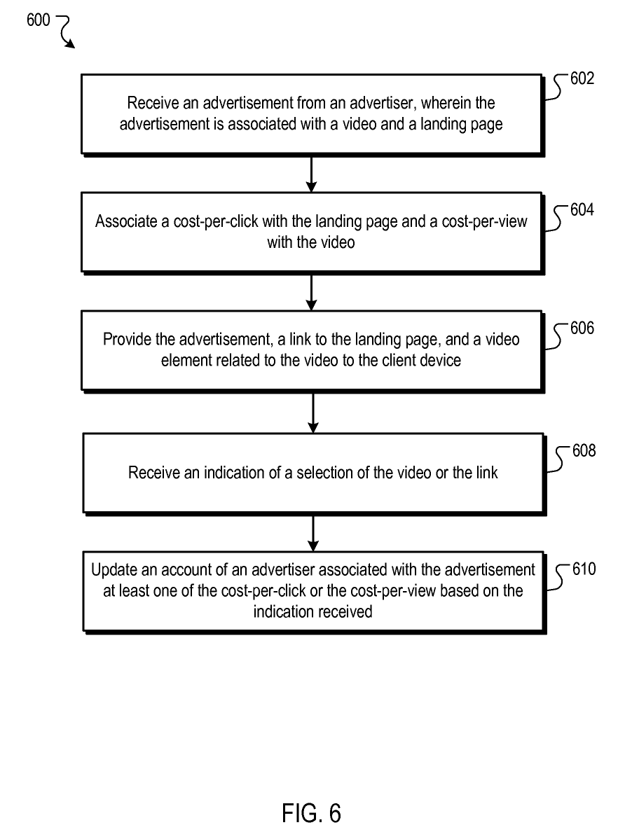

FIG. 6 is a flow diagram of another example process 600 for charging an advertiser associated with a video. The process 600 can, for example, be implemented in a system such as the system 200 of FIG. 2.

Stage 602 receives an advertisement from an advertiser, wherein the advertisement is associated with a video and a landing page. For example, the ad server 202 can receive an advertisement from an advertiser, wherein the advertisement is associated with a video and a landing page.

Stage 604 associates a cost-per-click with the landing page and a cost-per-view with the video. For example, the ad server 202 can associate a cost-per-click with the landing page and a cost-per-view with the video.

Stage 606 provides the advertisement, a link to the landing page, and a video element related to the video to the client device. For example, the ad server 202 can provide the advertisement, a link to the landing page, and a video element related to the video to the client device.

Stage 608 receives an indication of a selection of the video or the link. For example, the ad server 202 can receive an indication of a selection of the video or the link.

Stage 610 updates an account of an advertiser associated with the advertisement at least one of the cost-per-click or the cost-per-view based on the indication received. For example, the ad server 202 can update an account of an advertiser associated with the advertisement at least one of the cost-per-click or the cost-per-view based on the indication received.

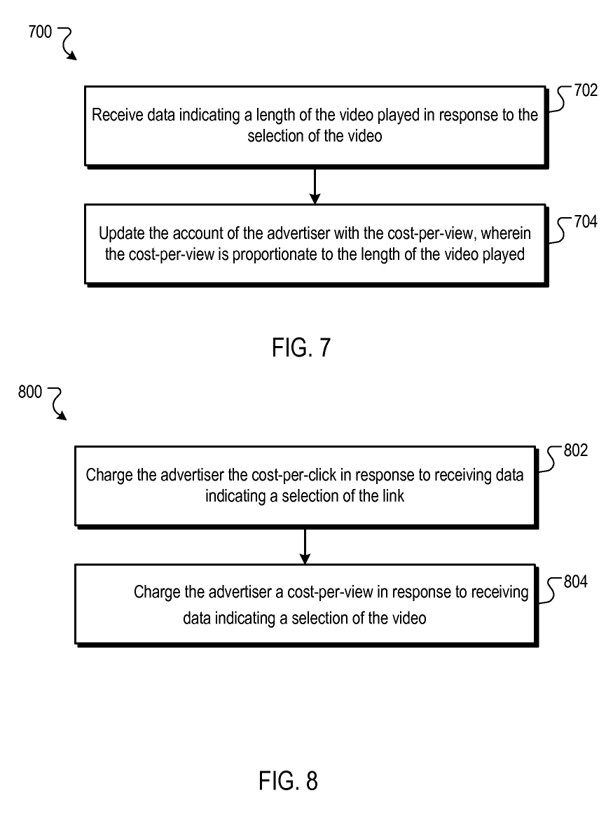

FIG. 7 is another flow diagram of another example process 700 for receiving an indication of a selection of the video or a link. The process 700 can, for example, be implemented in a system such as the system 200 of FIG. 2.

Stage 702 receives data indicating a length of the video played in response to the selection of the video. For example, the ad server 202 can receive data indicating a length of the video played in response to the selection of the video.

Stage 704 updates the account of the advertiser with the cost-per-view, wherein the cost-per-view is, for example, a function of the length of the video played. For example, the ad server 202 can update the account of the advertiser with the cost-per-view, wherein the cost-per-view is a function of the length of the video played. While reference is made to a proportional function, other functions can be applied. For example, a function that is weighted more heavily on the front end (for exposure to a first potion of the video) can be applied to the pricing. Alternatively, more weight can be applied to reaching the end of the video. In still other implementations, a bonus pricing can be applied for reaching the end of the video (e.g., a premium over and above the cost per view).

FIG. 8 is a flow diagram of an example process for calculating relevancy measures for the videos based on the one or more keywords. The process 800 can, for example, be implemented in a system such as the system 200 of FIG. 2.

Stage 802 charges the advertiser the cost-per-click in response to receiving data indicating a selection of the link. For example, the ad server 202 can charge the advertiser the cost-per-click in response to receiving data indicating a selection of the link.

Stage 804 charges the advertiser a cost-per-view in response to receiving data indicating a selection of the video. For example, the ad server 202 can charge the advertiser a cost-per-view in response to receiving data indicating a selection of the video.

FIG. 9 is a schematic diagram of an example computer system 900 that can be utilized to implement the systems and methods described herein. The system 900 includes a processor 910, a memory 920, a storage device 930, and an input/output device 940. Each of the components 910, 920, 930, and 940 can, for example, be interconnected using a system bus 950. The processor 910 is capable of processing instructions for execution within the system 900. In some implementations, the processor 910 is a single-threaded processor. In other implementations, the processor 910 is a multi-threaded processor. The processor 910 is capable of processing instructions stored in the memory 920 or on the storage device 930.

The memory 920 stores information within the system 900. In some implementations, the memory 920 is a computer-readable medium. In other implementations, the memory 920 is a volatile memory unit. In still other implementations, the memory 920 is a non-volatile memory unit.

The storage device 930 is capable of providing mass storage for the system 900. In some implementations, the storage device 930 is a computer-readable medium. In various different implementations, the storage device 930 can, for example, include a hard disk device, an optical disk device, or some other large capacity storage device.

The input/output device 940 provides input/output operations for the system 900. In some implementations, the input/output device 940 can include one or more network interface devices, e.g., an Ethernet card, a serial communication device, e.g., and a RS-232 port, and/or a wireless interface device, e.g., and an 802.11 card. In other implementations, the input/output device can include driver devices configured to receive input data and send output data to other input/output devices, e.g., keyboard, printer and display devices 960. Other implementations, however, can also be used, such as mobile computing devices, mobile communication devices, set-top box television client devices, etc.

Although the above description refers to a content item such as an advertisement, content items such as video and/or audio files, web pages for particular subjects, news articles, etc. can also be used.

Furthermore, the features and methods described can also be used in another form of online advertising such as ad syndication, which allows advertisers to extend their marketing reach by distributing advertisements to additional partners. For example, third party online publishers can place an advertiser's text or image advertisements on web properties with desirable content to drive online customers to the advertiser's website. An example of such a system is AdSense™ offered by Google, Inc. The features and methods described above can be used to allow the display of video elements along with the advertisements placed on the publisher's websites.

The apparatus, methods, flow diagrams, and structure block diagrams described in this patent document may be implemented in computer processing systems including program code comprising program instructions that are executable by the computer processing system. Other implementations may also be used. Additionally, the flow diagrams and structure block diagrams described in this patent document, which describe particular methods and/or corresponding acts in support of steps and corresponding functions in support of disclosed structural means, may also be utilized to implement corresponding software structures and algorithms, and equivalents thereof.

This written description sets forth the best mode of the invention and provides examples to describe the invention and to enable a person of ordinary skill in the art to make and use the invention. This written description does not limit the invention to the precise terms set forth. Thus, while the invention has been described in detail with reference to the examples set forth above, those of ordinary skill in the art may effect alterations, modifications and variations to the examples without departing from the scope of the invention.

What is claimed is:

1. A computer-implemented method, comprising:
receiving a query including one or more keywords;
identifying a content item relevant to the one or more keywords, wherein the content item is associated with a video;
generating display data for displaying the content item;
generating video selection data for displaying a video element proximate to the content item;
providing the display data and the video selection data to a device; and
updating an account of a sponsor associated with the content item an amount in response to receiving data indicating an interaction with the content item or the video element.

2. The method of claim 1, wherein updating an account of an sponsor associated with the content item an amount in response to receiving data indicating interaction with the video element comprises:
updating the account of a sponsor a cost-per-click in response to receiving data indicating a selection of the content item; and
updating the account of the sponsor a cost-per-view in response to receiving data indicating a selection of the video element.

3. The method of claim 2, wherein the cost-per-view is a predetermined amount charged for any length of the video played.

4. The method of claim 1, further comprising charging a sponsor associated with the content item, wherein charging an amount in response to receiving data indicating a selection of the video element comprises:
identifying a minimum cost-per-view associated with the video element from the sponsor; and
charging the sponsor the minimum cost-per-view in response to receiving data indicating a selection of the video element.

5. The method of claim 1, further comprising:
receiving data indicating a length of the video played in response to the selection of the video element; and
charging the sponsor a cost-per-view, wherein the cost-per-view is proportionate to the length of the video element played.

6. The method of claim 1, further comprising:
in response to receiving data indicating selection of the video element, determining whether data is also received indicating a selection of the content item; and
updating the account of a sponsor a cost-per-view and a cost-per-click based on the determination that data was received indicating a selection of the content item.

7. A method, comprising:
receiving an advertisement from an advertiser, wherein the advertisement is associated with a video and a landing page;
associating a cost-per-click with the landing page and a cost-per-view with the video;
providing the advertisement, a link to the landing page, and a video element related to the video to the client device;
receiving an indication of a selection of the video or the link; and
updating an account of an advertiser associated with the advertisement at least one of the cost-per-click or the cost-per-view based on the indication received.

8. The method of claim 7, wherein the cost-per-click is a predetermined amount charged for any length of the video played.

9. The method of claim 7, wherein associating a cost-per-click with the landing page and a cost-per-view with the video comprises:
receiving a maximum cost-per-click and the cost-per-view from an advertiser associated with the advertisement.

10. The method of claim 9, wherein receiving an indication of a selection of the video or a link comprises:
receiving data indicating a length of the video played in response to the selection of the video.
updating the account of the advertiser with the cost-per-view, wherein the cost-per-view is a function of the length of the video played.

11. The method of claim 6, wherein updating an account of the advertiser associated with the advertisement at least one of the cost-per-click or the cost-per-view based on the indication received comprises:
charging the advertiser the cost-per-click in response to receiving data indicating a selection of the link.

12. The method of claim 6, wherein updating an account of the advertiser at least one of the cost-per-click or the cost-per-view based on the indication received comprises:
charging the advertiser a cost-per-view in response to receiving data indicating a selection of the video.

13. The method of claim 6, wherein the cost-per-view is a minimum cost-per-view.

14. The method of claim 13, wherein a cost-per-view is an amount associated with a selection of the video element.

15. A system, comprising:
a data store configured to store an advertisement and a video associated with the advertisement; and
an advertisement engine comprising instructions executable by a processing system and stored in a computer readable medium, wherein execution of the instructions causes the processing system to perform the operations of:
receive a query including one or more keywords;
identify a content item relevant to the one or more keywords, wherein the content item is associated with a video;
generate display data for displaying the content item;
generate video selection data for displaying a video element proximate to the content item;
provide the display data and the video selection data to a device; and
update an account of a sponsor associated with the content item an amount in response to receiving data indicating an interaction with the content item or the video element.

16. The system of claim 15, wherein the advertisement engine is further operable to:
update the account of a sponsor a cost-per-click in response to receiving data indicating a selection of the content item; and
update the account of the sponsor a cost-per-view in response to receiving data indicating a selection of the video element.

17. The system of claim 16, wherein the cost-per-view is a predetermined amount charged for any length of the video played.

18. The system of claim 15, wherein the advertisement engine is further operable to:
identify a minimum cost-per-view associated with the video element from the sponsor; and
charge the sponsor the minimum cost-per-view in response to receiving data indicating a selection of the video element.

19. The system of claim 15, wherein the advertisement engine is further operable to:
receive data indicating a length of the video played in response to the selection of the video element; and
charge the sponsor a cost-per-view, wherein the cost-per-view is a function of the length of the video element played.

20. The system of claim 15, wherein the advertisement engine is further operable to:
in response to receiving data indicating selection of the video element, determining whether data is also received indicating a selection of the content item; and
update the account of a sponsor a cost-per-view and a cost-per-click based on the determination that data was received indicating a selection of the content item.

21. A system, comprising:
a data store configured to store an advertisement and a video associated with the advertisement; and
an advertisement engine comprising instructions executable by a processing system and stored in a computer readable medium, wherein execution of the instructions causes the processing system to perform the operations of:
receive an advertisement from an advertiser, wherein the advertisement is associated with a video and a landing page;
associate a cost-per-click with the landing page and a cost-per-view with the video;
provide the advertisement, a link to the landing page, and a video element related to the video to the client device;
receive an indication of a selection of the video or the link; and
update an account of an advertiser associated with the advertisement at least one of the cost-per-click or the cost-per-view based on the indication received.

22. The system of claim 21, wherein the cost-per-click is a predetermined amount charged for any length of the video played.

23. The system of claim 21, wherein the advertisement engine is further operable to:
receive a maximum cost-per-click and the cost-per-view from an advertiser associated with the advertisement.

24. The system of claim 23, wherein the advertisement engine is further operable to:
receive data indicating a length of the video played in response to the selection of the video.

25. A system, comprising:
means for receiving from a client device a query including one or more keywords;
means for identifying an advertisement relevant to the one or more keywords, wherein the advertisement is associated with a video;
means for generating display data for displaying the advertisement at the client device;
means for generating video selection data for displaying a video element proximate to the advertisement at the client device;
means for providing the display data and the video selection data to the client device; and
means for updating an account of an advertiser associated with the advertisement an amount in response to receiving data indicating a selection of the advertisement or the video element.
